(19) United States
(12) Patent Application Publication
(10) Pub. No.: US 2004/0001974 A1
(43) Pub. Date: Jan. 1, 2004

(54) Magnetically stable particulate magnetic recording medium having high signal-to noise ratio and method of assessing magnetic stability thereof

(75) Inventor: Michael P. Sharrock, St. Paul, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 10/186,126

(22) Filed: Jun. 28, 2002

(51) Int. Cl. B32B 3/00

(52) U.S. Cl. 428/694 B; 428/694 R

(57) ABSTRACT

A method of determining the coercivity ratio of magnetic recording medium, and magnetic recording medium having a magnetizable layer with a Performance Coercivity Ratio (PCR) of at least 1.06 and preferably less than 1.4.

### FIELD OF THE INVENTION

The invention relates to particulate magnetic recording media and methods for assessing the magnetic stability and signal-to-noise ratio of such recording media.

### BACKGROUND

Magnetic recording media generally comprise at least one magnetizable layer (also commonly referenced as an “information storing layer” or “magnetic recording layer”) coated onto at least one side of a substrate. For particulate magnetic recording media, the magnetizable layer comprises particles (also commonly reference as “magnetic pigment particles” or “magnetic pigment”) dispersed in a polymeric binder. The polymeric binder of magnetic recording medium is most commonly prepared using a polymer with a hard segment (i.e., a polymer with relatively high glass transition temperature and modulus), and a soft segment (i.e., a polymer with relatively low glass transition temperature and modulus). In addition to the binder and magnetic pigment, the magnetic layer may also include other components such as lubricants, abrasives, thermal stabilizers, catalysts, crosslinkers, antioxidants, dispersants, wetting agents, fungicides, bactericides, surfactants, antistatic agents, nonmagnetic pigments, coating aids, and the like.

A highly desired property of magnetic recording media is a high signal to noise ratio (SNR). It is generally recognized that the SNR of magnetic recording media increases as the magnetic microstructure size of the magnetizable layer on the magnetic recording media decreases. One important aspect of microstructure size of a magnetizable layer is the size of the magnetic particles used in the magnetizable layer. Hence, while other factors must also be considered, an increase in SNR can generally be achieved through a decrease in the particle size of the magnetic particles used in the magnetizable layer on a magnetic recording media.

Unfortunately, a smaller magnetic microstructure, e.g., smaller particle size, also causes a loss of magnetic stability. While a high SNR is desired, magnetic stability is essential to proper performance and consumer acceptance of magnetic recording media. Magnetic recording media, especially those incorporating magnetic particles of metallic composition, have in the past utilized particles that are substantially larger than would be required to ensure adequate magnetic stability. As smaller particles are developed, a need exists to measure the magnetic stability and assure that it has not been excessively compromised in the interest of achieving increased SNR. A need also exists to measure the effective relative magnetic microstructure size of a magnetizable layer so as to permit verification that the size is significantly smaller than that present in conventional material.

### SUMMARY OF THE INVENTION

The invention as described here consists of magnetic recording media in which the effective magnetic microstructure size of the magnetizable layer, governed primarily by individual magnetic particle size, is demonstrably smaller than that used in conventional recording media, and a method for measuring this microstructure size.

The behavior of a magnetizable layer in response to an applied magnetic field is known to depend not only on the field strength but also on the duration of the field's application and and/or the rate of change (sweep rate) of the field strength. See, Sharrock, Michael P., “Measurement and Interpretation of Magnetic Time Effects in Recording Media,” IEEE Transactions on Magnetics, vol. 35, pp. 4414-4422, November, 1999 (“First Sharrock Article”), and Sharrock, Michael P., “Recent Advances in Metal Particulate Recording Media: Toward the Ultimate Particle,” IEEE Transactions on Magnetics, Vol. 36, pp. 2420-2425, September 2000 (“Second Sharrock Article”). Magnetic phenomena thus have a sensitivity to time-scale. In particular, the coercivity of a magnetizable layer (i.e., the strength of the field needed to reduce the moment of an initially saturated sample to zero) depends upon the time-scale of the process producing the magnetization change. Coercivity of a magnetizable layer is known to decrease as the time allowed for magnetic switching is increased, or equivalently, as the sweep rate is decreased.

This time-scale dependence becomes more pronounced as the size of the microstructure of a magnetizable layer decreases. The method described herein utilizes this relationship to reliably establish the relative magnetic microstructure size of a magnetizable layer on a magnetic recording media such that an indication of the relative magnetic stability and the relative SNR capability of the magnetizable layer can be obtained from measurements of the coercivity value H_{c} of the magnetizable layer at a higher sweep rate and at a lower sweep rate.

Briefly, the method comprises the steps of (1) testing a sample of the recording medium at a first field sweep rate and a first maximum magnetic field to obtain a first coercivity value for the magnetizable layer on the magnetic recording medium, wherein the amplitude of the first maximum magnetic field is sufficient to switch essentially all (i.e., >99%) of the magnetic moment, (2) testing the sample at a second sweep rate and a second maximum magnetic field to obtain a second coercivity value for the magnetizable layer on the magnetic recording medium, wherein (a) the second maximum magnetic field is sufficient to switch essentially all (i.e., >99%) of the magnetic moment and (b) the first sweep rate is at least 1,000 times greater than the second sweep rate, and (3) calculating a coercivity ratio for the magnetizable layer on the magnetic recording medium by dividing the first coercivity value by the second coercivity value.

The first field sweep rate is preferably about 2 MOe/s and the second field sweep rate is preferably about 30 Oe/s.

The value of the coercivity ratio of a magnetizable layer is indicative of the microstructure size of the magnetizable layer, and thereby provides a relative indication of the SNR and also of the magnetic stability for the magnetizable layer.

The class of magnetic recording media described herein has an improved SNR and an adequately magnetically stable magnetizable layer. Briefly, this new class of magnetic recording media has at least one magnetizable layer which includes a binder and a plurality of magnetic particles and which has a performance coercivity ratio (PCR) (i.e., the coercivity ratio obtained when the first coercivity value is a high sweep rate coercivity H_{c(high)} obtained utilizing the specific High-Sweep-Rate Coercivity Testing Method set forth herein, and the second coercivity value is a low sweep rate coercivity H_{c(low)} obtained utilizing the specific Low-Sweep-Rate Coercivity Testing Method set forth herein) of at least 1.06. Preferably the magnetizable layer has a PCR of less than 1.4.

### BRIEF DESCRIPTION OF THE DRAWINGS

FIG. 1 is a graph of PCR plotted against the average particle length for a number of test tapes containing commercially available particles of partially metallic composition (known in the industry as “MP”).

FIG. 2 is a graph of KV/kT plotted against PCR.

### DETAILED DESCRIPTION OF THE INVENTION INCLUDING A BEST MODE

Definitions

As utilized herein, including the claims, the term “coercivity” means the field at which the magnetic moment of a sample of a recording medium attains the value of zero, as measured in the direction parallel with the applied field, when the sample is magnetically switched through its hysteresis loop with the sample mounted such that its direction of maximum magnetic remanence is aligned with the applied field.

As utilized herein, including the claims, the term “sweep rate” means the absolute value of the rate of change with respect to time, of the magnitude of the magnetic field which is applied to the sample. This field is to be bidirectional, but aligned with a constant axis which is aligned with the sample's direction of maximum magnetic remanence.

As utilized herein, including the claims, the phrase “performance coercivity ratio” (PCR) means the ratio of high-sweep-rate coercivity to low-sweep-rate coercivity for a given sample of magnetic recording media.

As utilized herein, including the claims, the phrase “time-scale coercivity testing methods” refers to the “high-sweep-rate coercivity” and “low-sweep-rate coercivity” testing methods set forth herein.

As utilized herein, including the claims, the phrase “high-sweep-rate coercivity” (H_{c(high)} means the coercivity measured in accordance with the High-Sweep-Rate Coercivity Testing Method set forth herein.

As utilized herein, including the claims, the phrase “low-sweep-rate coercivity” (H_{c(low)}) means the coercivity measured in accordance with the Low-Sweep-Rate Coercivity Testing Method set forth herein.

Construction of Particulate Magnetic Recording Media

Magnetic recording media generally comprise at least one magnetizable layer (also commonly referred to as an “information storing layer” or “magnetic recording layer”) coated onto at least one side of a substrate. For particulate magnetic recording media, the magnetizable layer comprises magnetic particles dispersed in a polymeric binder.

Magnetic Particles

Magnetic particles preferred for use in the magnetizable layer of particulate magnetic recording media are acicular or needle like magnetic particles. The average particle length of these particles along the major axis is preferably less than about 0.2 μm, and more preferably, less than about 0.1 μm. The particles preferably exhibit an axial ratio (i.e., a length to diameter ratio) of from about 3 to 1 up to about 8 to 1. Preferred particles have a specific surface area of at least about 40 m²/g, more preferably of at least about 50 m²/g. Typical acicular particles of this type include, for example, particles of ferri- or ferromagnetic metal oxides such as gamma-ferric oxide (γ—Fe₂O₃), complex oxides of iron and cobalt, various ferrites, and most preferably particles of passivated metal (such as iron, cobalt, or iron/cobalt alloy). Alternatively, small tabular particles such as barium ferrites and the like can be employed.

The particles can be doped with one or more ions such as ions of titanium, tin, cobalt, nickel, zinc, manganese, chromium, or the like, as is known in the art. The particles may also contain aluminum, silicon, boron, and/or compounds of these elements.

The magnetic particles can be present in the dispersion in an amount of from about 50% to about 90% by weight, preferably about 60% to about 80% by weight.

A preferred particle is a magnetic alloy particle having high coercivities and high saturation magnetization that preferably include about 15 to 45 atomic %, preferably 20 to 45 atomic percent, Co based on the amount of Fe present (i.e., 100×(atoms of Co/atoms of Fe)). Preferably, these alloy particles have coercivities greater than about 1800 Oersteds (Oe), more preferably from about 1800 to about 2800 Oe, and even more preferably, about 2000 to about 2800 Oe. The saturation of magnetization of the alloy particles is preferably greater than or equal to 100 emu/g and, more preferably, greater than 120 emu/g. Such metal alloy particles can be prepared by the method described in U.S. Pat. No. 5,735,969 (Lown et al.), and are commercially available from a number of sources such as Dowa Mining, Kanto Denka, and Toda Kogyo Corporation.

Magnetic particles for use in the present invention may incorporate at least a first surface treatment agent that is desirably adsorbed onto the surfaces of the magnetic particles. The surface treatment agent is generally a compound comprising at least one acidic group and at least one electron withdrawing group. Advantageously, the use of a surface treatment agent with this kind of multiple functionality improves dispersability of the treated magnetic particles in polymeric binders having quaternary ammonium functionality. As a result, the corresponding magnetic recording media are easier to manufacture and have better electromagnetic and mechanical performance properties than if the surface treatment agent lacked one or both of the acid or electron withdrawing functionalities.

A wide variety of acidic groups may be used as the acidic group of the surface treatment agent with beneficial results. Representative examples of suitable acidic groups include an anhydric group, a —COOH group, sulfonic acid, a phosphonic acid group, salts of such groups, combinations of these, and the like. Of these, —COOH is generally preferred in combination with metal magnetic particles. A salt of an acidic group is also deemed to be an acidic group within the scope of the invention.

As used herein, the term “electron-withdrawing” group is a group which, if substituted for a hydrogen atom (other than the acidic H) on a carboxylic acid would make the acid have a lower pKa, i.e. the functional group has a Hammett Substituent Constant greater than 0.1 as described in Introduction to Organic Chemistry, Andrew Streitwieser, Jr. and Clayton H. Heathcock, McMillan Publishing Co., Inc. (NY, N.Y. 1976) pp. 947-949. Representative examples of electron withdrawing groups include nitro, chloro, bromo, fluoro, iodo, oxo, perfluoroalkyl (such as trifluoromethyl), perfluoroalkoxy, hydroxy, cyano, combinations of these, and the like.

A surface treatment agent can be incorporated into the magnetizable layer to ease dispersion and help prevent agglomeration of the magnetic particles during preparation of the magnetic recording medium. The optimum amount of surface treatment agent will depend upon a number of factors including the acid equivalent weight of the surface treatment agent, the specific surface area of the magnetic particles treated, the pH of the magnetic particles, and the like.

In one embodiment, the surface treatment agent is a compound having the formula

E-X-A

wherein E is the electron withdrawing group, A is the acidic group, and X comprises an aromatic moiety. Preferably, X is an aromatic ring and E and A are substituents of the aromatic ring at meta or para positions relative to each other. More preferably, E and A are at a para position relative to each other in order to maximize the spacing between E and A.

Binders

Suitable binders that can be used in the magnetic layer include, for example, vinyl chloride vinyl acetate copolymers, vinyl chloride vinyl acetate vinyl alcohol ter-polymers, vinyl chloride vinyl acetate maleic acid ter-polymers, vinyl chloride vinylidene chloride copolymers, vinyl chloride acrylonitrile copolymers, acrylic ester acrylonitrile copolymers, acrylic ester vinylidene chloride copolymers, methacrylic ester vinylidene chloride copolymers, methacrylic esterstyrene copolymers, thermoplastic polyurethane resins, phenoxy resins, polyvinyl fluoride, vinylidene chloride acrylonitrile copolymers, butadiene acrylonitrile copolymers, acrylonitrile butadiene acrylic acid copolymers, acrylonitrile butadiene methacrylic acid copolymers, polyvinyl butyral, polyvinyl acetal, cellulose derivatives, styrene butadiene copolymers, polyester resins, phenolic resins, epoxy resins, thermosetting polyurethane resins, urea resins, melamine resins, alkyl resins, urea formaldehyde resins, and the like.

The binders may be provided in a suitable non-aqueous solvent, such as methylene chloride, acetone, methyl ethyl ketone, methyl isobutyl ketone, ethyl acetate, butyl acetate, cyclohexanone, butyl alcohol, N,N-dimethylformamide, toluene, and mixtures thereof

Common binders include polyurethanes, non-halogenated vinyl copolymers, halogenated vinyl copolymers, and a combination thereof As used herein, the term “nonhalogenated” means that the copolymer contains no covalently bound halogen atoms. Thus, the term “nonhalogenated” excludes vinyl halide monomers such as vinyl chloride or vinylidene chloride as monomeric components of the copolymer, but the term “nonhalogenated” does not exclude monomeric components such as (meth)acryloyloxyethyl trimethylammonium chloride in which chlorine is present as a chloride anion. As used herein, the prefix “(meth)acryl-” means “methacryl-” or “acryl-”. The term “vinyl” with respect to a polymeric material means that the material comprises repeating units derived from vinyl monomers. As used with respect to a vinyl monomer, the term “vinyl” means that the monomer contains a moiety having a free-radically polymerizable carbon-carbon double bond. Monomers having such moieties are capable of copolymerization with each other via the carbon-carbon double bonds.

One useful polyurethane is a carboxyl polyurethane polymer, such as that described in U.S. Pat. No. 5,759,666 (Carlson et al.). The carboxyl polyurethane polymer typically comprises the reaction product of a mixture comprising: (i) one or more polyisocyanates, (ii) a carboxylic acid functional polyol, and, (iii) optionally one or more polyols defined to exclude the former carboxylic acid functional polyol, wherein the number of isocyanate-reactive groups present in the mixture prior to reaction exceeds the number of isocyanate groups and at least about 0.2 meq of carboxylic acid groups are present on the carboxyl polyurethane polymer per gram of carboxyl polyurethane polymer. Typically, the reaction product has a number average molecular weight from about 2000 to about 50,000, preferably from about 5000 to about 30,000.

The term “polyisocyanate” refers to any organic compound that has two or more reactive isocyanate (i.e., —NCO) groups in a single molecule that can be aliphatic, alicyclic, aromatic, and a combination thereof, and includes diisocyanates, triisocyanates, tetraisocyanates, etc., and combinations thereof. Preferred polyisocyantes are the diisocyanates such as diphenylmethane diisocyanate, isophorone diisocyanate, toluene diisocyanate, hexamethylene diisocyanate, tetramethylxylene diisocyanate, p-phenylene diisocyanate, and combinations thereof.

The term “polyol,” as used herein, refers to polyhydric alcohols containing an average of one or more hydroxyl groups and includes monohydric alcohols, diols, triols, tetrols, etc. Preferred polyols are diols that include both low molecular weight (i.e., having less than about 500 number average molecular weight) and oligomeric diols, typically having a number average molecular weight from about 500 to about 5000. Representative examples of low molecular weight diols include, but are not limited to, ethylene glycol, propylene glycol, diethylene glycol, diols having polar functional groups, diols bearing ethylenic unsaturation (e.g., 3-allyloxy-1,2-propandiol, 1-glyceryl (meth)acrylate, etc.) and fluorinated diols. Representative examples of oligomeric diols include, but are not limited to, polyether diols, polyester diols, polyether triols, and polyester triols.

Another useful polyurethane is a phosphonated polyurethane, such as described in U.S. Pat. No. 5,501,903 (Erkkila et al.). Preferably, the phosphonated polyurethane includes (i) nitrogen forming part of the backbone of the polymer, (ii) a single bond or divalent linking group (preferably including up to 4 linear carbon atoms), and (iii) two pendant groups independently selected from of an alkyl group, a cycloalkyl group, an aryl group, or together comprise the necessary carbon atoms to complete a ring. The phosphonated polyurethane is preferably formed by reaction of a soft segment diol in which the hydroxyl groups are separated by a flexible chain (typically having a molecular weight of more than 300 and often including a polycaprolactone diol, a hard segment diol in which the hydroxyl groups are separated by a relatively inflexible chain (typically having a molecular weight of less than 300 and often including neopentyl glycol, a triol (e.g., a polycaprolactone triol), a diisocyanate (e.g., toluene diisocyanate, 4,4-diphenylmethane diisocyanate, ocisophorene diisocyanate), and a dialkyl phosphonate (e.g., diethyl bis-(2-hydroxyethyl) aminomethylphosphonate).

An example of a useful quaternary ammonium-containing polyurethane is a polymeric quaternary ammonium compound described in U.S. Pat. No. 5,759,666 (Carlson et al.). In particular, preferred polymeric quaternary ammonium compounds have a number average molecular weight greater than about 500 and are selected from the group of quaternary ammonium polyurethanes, quaternary ammonium functional non-halogenated vinyl copolymers, and combinations thereof.

A suitable binder may include quaternary ammonium functionality. As used herein, the term “quaternary ammonium functionality” refers to moieties of the formula

(*N(R)₃)⊕MΘ

wherein (i) the bond denoted with the asterisk is attached to the backbone of the polymeric binder resin either directly or indirectly through a difunctional linking group; (ii) each R may independently be any suitable moiety or co-member of a ring structure, and is preferably H or an alkyl group of 1 to 10 carbon atoms such as —CH₃; and (iii) M is any suitable counter anion such as Cl⁻, Br⁻, or the like. The term “quaternary ammonium functionality” also would encompass sulfobetaines, (e.g., —N⁺(CH₃)₂(CHCH₂CH₂SO₃⁻)).

In one embodiment, the quaternary ammonium functional polymer is a nonhalogenated vinyl copolymer which is incorporated into the polymeric binder as the “hard resin” component having a relatively high glass transition temperature (T_{g}).

In another embodiment, the nonhalogenated vinyl copolymer is of the type comprising a plurality of pendant quaternary ammonium groups, a plurality of pendant crosslinkable moieties such as OH groups or moieties having carboncarbon double bonds, and a plurality of pendant nitrile groups. Without wishing to be bound by theory, it is believed that the nitrile groups may promote the compatibility of these vinyl copolymers with polyurethanes. It is also believed that the pendant hydroxyl groups of the vinyl copolymer not only facilitate dispersion of the magnetic particles in the polymeric binder, but also promote solubility, cure and compatibility with other polymers. The quaternary ammonium groups of the vinyl copolymer facilitate dispersion of the magnetic particles in the polymeric binder.

In yet another embodiment, the quaternary ammonium functional polymer is a quaternary ammonium polyurethane that has at least one quaternary ammonium group pendant from a polyurethane chain of molecular weight greater than about 500.

Another useful non-halogenated vinyl copolymer is one having a plurality of pendant nitrile groups, a plurality of pendant hydroxyl groups, and at least one pendant dispersing group, such as described in U.S. Pat. Nos. 5,501,903 (Erkkila et al.) and 5,510,187 (Kumar et al.). One such non-halogenated vinyl copolymer is comprised of (i) a nonhalogenated vinyl copolymer of monomers comprising 5 to 40, preferably 15 to 40, parts by weight of (meth)acrylonitrile; (ii) 30 to 80 parts by weight of one or more nonhalogenated, nondispersing, vinyl monomers; (iii) 1 to 30 parts by weight of a nonhalogenated, hydroxyl functional, vinyl monomer; (iv) and 0.25 to 10 parts by weight of a nonhalogenated, vinyl monomer bearing a dispersing group. The dispersing group can be selected from quaternary ammonium, acid or salt of carboxyl, acid or salt of phosphate or phosphonate, acid or salt of sulfate or sulfonate, and mixtures thereof. When the dispersing group is quaternary ammonium, it is preferred that the vinyl monomer bearing a dispersing group is (meth)acryloyloxyethyl trimethylammonium chloride.

The nonhalogenated, nondispersing, vinyl monomer is preferably selected from styrene; an alkyl ester of (meth)acrylic acid wherein the alkyl group of the alkyl ester has 1 to 20 carbon atoms; and a blend comprising styrene and such an alkyl ester (e.g., methyl (meth)acrylate, more preferably methyl methacrylate) wherein the weight ratio of styrene to the alkyl ester is in the range from 10:90 to 90:10.

Halogenated vinyl copolymers are also useful as binders. These include vinyl chloride resins, vinyl chloride-vinyl acetate resins, vinyl chloride-vinyl acetate-vinyl alcohol resins, vinyl chloride-vinyl acetate-maleic anhydride resins, and combinations thereof, such as those described in U.S. Pat. No. 5,763,046 (Ejiri et al.). These resins preferably also include one or more bonded polar groups bonded. Preferred polar groups include SO₃M₁, COO M₁, OSO₃ M₁, P=O(O M₂)O M₃, —OP═O(O M₂)O M₃, —NRX, OH, NR₁, N⁺R₂ (wherein R is a hydrocarbon group), an epoxy group, SH, and CN. Another useful type of vinyl chloride resin is a vinyl chloride copolymer containing epoxy groups (e.g., a copolymer containing a vinyl chloride repeating unit, an epoxy-containing repeating unit, and, if desired, a polar group-containing unit (e.g., —SO₃M, —OSO₃M, —COOM, and —PO(OM)₂, wherein M is hydrogen or an alkali metal)). Of these, a copolymer containing a repeating epoxy group and a repeating unit containing —SO₃Na are particularly useful.

The polymers mentioned above may be prepared by polymerization methods known in the art, including but not limited to bulk, solution, emulsion and suspension free-radical polymerization methods. For example, according to the solution polymerization method, copolymers may be prepared by dissolving the desired monomers in an appropriate solvent, adding a chain-transfer agent, a free-radical polymerization initiator, and other additives known in the art, sealing the solution in an inert atmosphere such as nitrogen or argon, and then agitating the mixture at a temperature sufficient to activate the initiator.

In addition to the binder and magnetic pigment, the magnetic layer may also include other components such as lubricants, abrasives, thermal stabilizers, catalysts, crosslinkers, antioxidants, dispersants, wetting agents, head-cleaning agents, fungicides, bactericides, surfactants, antistatic agents, nonmagnetic pigments, coating aids, surface treatment agents, and the like.

One preferred type of crosslinker is a polyisocyanate crosslinker known to the magnetic recording media art to cure at a glass transition temperature of greater than about 100° C. useful for production layers of high glass transition temperature and hardness. A particularly useful type of polyisocyanate crosslinker is the reaction product of an excess of a diisocyanate with low number average molecular weight (i.e., under about 200) diols and triols. A typical and widely used polyisocyante crosslinker comprises the adduct of toluene diisocyanate with a mixture of trimethylol propane and a diol such as butane diol or diethylene glycol. A preferred material of this type is available under the trade designation MONDUR CB-55N from Bayer Corporation. Other useful high T_{g} crosslinkers are available under the trade designations MONDUR CB-601, MONDUR CB-701, MONDUR MRS, and DESMODUR L (all available from Bayer Corporation) and CORONATE L (available from Nippon Polyurethane). Additional isocyanate crosslinking agents are described in U.S. Pat. No. 4,731,292 (Sasaki et al.).

A toughened polyisocyanate crosslinker which cures to a tough and flexible, rather than a brittle, film may be desirable for some applications. Useful toughened polyisocyanate crosslinkers are described in U.S. Pat. No. 5,759,666 (Carlson et al.) and are obtained as the reaction product of an excess of a polyisocyanate with polyols, including 10-80% by weight of an oligomeric polyol which acts as a toughening segment. The oligomeric polyols useful in making toughened polyisocyanate curatives have a number average molecular weight of about 500 to about 5000 and a glass transition temperature of lower than about 0° C., preferably lower than about minus 20° C. The oligomeric polyols are preferably selected from the group consisting of polyester diols, polyester triols, polyether diols, polyether triols, polycarbonate diols, polycarbonate triols, and mixtures thereof.

One of the preferred toughened polyisocyanate crosslinkers is made from the reaction product of MONDUR CB-55N with 45 weight percent of a polycaprolactone diol of 1300 number average molecular weight. This modified MONDUR CB-55N provides a faster cure and a tougher coating. The modified MONDUR CB-55N may be used at a loading of between about 20 and about 60 weight percent, most preferably about 30 to about 50 weight percent, based upon the weight of formulation solids exclusive of particles.

Suitable lubricants include those disclosed in U.S. Pat. Nos. 4,731,292 (Sasaki et al.), 4,784,907 (Matsufuji et al.), and 5,763,076 (Ejiri et al.). Such lubricants can provide desired frictional and processing characteristics. Specific examples of useful lubricants include but are not limited to those selected from the group consisting of C₁₀ to C₂₂ fatty acids, C₁ to C₁₈ alkyl esters of fatty acids, and mixtures thereof Other useful lubricants include silicone compounds such as silicone oils, fluorochemical lubricants, and fluorosilicones; and particulate lubricants such as powders of inorganic or plastic materials. Commonly preferred lubricants include myristic acid, stearic acid, palmitic acid, isocetyl stearate, oleic acid, and butyl and amyl esters thereof Mixtures of lubricants are often used, especially mixtures of fatty acids and fatty esters.

A suitable type of wetting agent are phosphoric acid esters such as monophosphorylated propylene oxide adducts of glycerol (e.g., the reaction product of 1 mole of phosphorous oxychloride with the reaction product of 10-11 moles of propylene oxide and 1 mole of glycerine).

Suitable head cleaning agents include but are not limited to those disclosed in U.S. Pat. Nos. 4,784,914 (Matsufuji et al.) and 4,731,292 (Sasaki et al.). Specific examples of useful cleaning agents include, but are not limited to, alumina, chromium dioxide, alpha iron oxide, and titanium dioxide particles of a size less than about 2 microns, preferably less than 0.5 microns, which have a Mohs hardness of greater than about 5 and which are added in an amount ranging from about 0.2 to about 20 parts per hundred parts of magnetic particles.

Method of Making Particulate Magnetic Recording Media

Briefly, to prepare such media, the components of the magnetic layer, including the magnetic particles, are combined with a suitable solvent and thoroughly mixed to form a homogeneous dispersion. The resulting dispersion is then coated onto the nonmagnetizable substrate with or without an intermediate layer(s) such as a magnetizable or nonmagnetizable sublayer containing magnetic or nonmagnetic particles, after which the coating is oriented (if desired), dried, calendered and/or cured as necessary and desired, and then slit into tapes or punched into discs.

Preferably, the plurality of magnetic particles is first prepared as a concentrated magnetic particle dispersion. The concentrated magnetic particle dispersion can be prepared by procedures known to those in the dispersion art. The dispersion can be prepared by the use of a dispersing machine, such as a high-speed impeller mill, an attritor, or a sand mill.

The concentrated magnetic particle dispersion can be diluted with a suitable non-aqueous organic solvent to make a magnetic coating composition. Typically, the binder is dissolved or dispersed in the non-aqueous organic solvent prior to adding the magnetic particles. Solvents useful for dilution of the concentrated magnetic dispersion include (i) ketones such as acetone, methyl ethyl ketone, methyl isobutyl ketone, cyclohexanone, and isophorone; (ii) esters such as methyl acetate, ethyl acetate, butyl acetate, isobutyl acetate, isopropyl acetate, ethyl lactate, and glycol monoethyl ether acetates; (iii) ethers such as diethyl ether, tetrahydrofuran, glycol dimethyl ethers, and dioxane; (iv) aromatic hydrocarbons such as benzene, toluene, xylene, cresol, chlorobenzene, and styrene; (v) chlorinated hydrocarbons such as methylene chloride, ethylene chloride, carbon tetrachloride, chloroform, ethylene chlorohydrin, and dichlorobenzene; (vi) N,N-dimethylformamide; and (vii) hexane.

For certain applications it may be desirable to incorporate the binder described herein in a coating composition that is not required to possess magnetic properties, such as a primer/adhesion promotion layer, an activator layer, a sublayer (typically located between the magnetic layer and the substrate), or a protective top layer. For example, a sublayer coating composition can comprise non-magnetizable particles, such as carbon black, alpha-iron oxide, aluminum oxide, titanium dioxide, zinc oxide, silica gel, calcium carbonate, barium sulfate, and mixtures thereof

Method of Determining Performance Coercivity Ratio (PCR)

As set forth in the definitions section, “performance coercivity ratio” (PCR) means the ratio of the coercivity value obtained at a higher sweep rate H_{c(high)} to the coercivity value obtained at a lower sweep rate H_{c(low)} for a given sample of magnetic recording media.

The maximum magnetic field used during testing to obtain the coercivity values at both the higher and lower sweep rates should be sufficient to switch essentially all (i.e., >99%) of the magnetic moment. Use of a maximum magnetic field which does not switch essentially all of the magnetic moment can produce inaccurate results.

High-Sweep-Rate Coercivity Testing Method

The high-sweep-rate coercivity H_{c(high)} of a magnetic recording medium sample is measured by magnetically switching the sample through its hysteresis loop at room temperature with a coil operated sinusoidally at 50 to 60 Hz with a maximum field amplitude sufficient to switch essentially all (i.e., >99%) of the magnetic moment, so as to achieve a field sweep rate of approximately 2 MOe/s during the portion of the measured hysteresis loop where the magnetic moment passes through the value of zero.

Low-Sweep-Rate Coercivity Testing Method

The low-sweep-rate coercivity H_{c(low)} of a magnetic recording medium sample is measured by magnetically switching a sample of the medium through its hysteresis loop at room temperature with a vibrating-sample magnetometer (VSM) or equivalent device operated at a maximum field amplitude sufficient to switch essentially all (i.e., >99%) of the magnetic moment and at a field sweep rate of 30±10 Oe/s during the portion of the measured hysteresis loop where the magnetic moment passes through the value of zero.

Significance of Performance Coercivity Ratio (PCR) Values

The PCR value of a magnetizable layer provides an indication of the relative SNR value and the relative magnetic stability of the magnetizable layer.

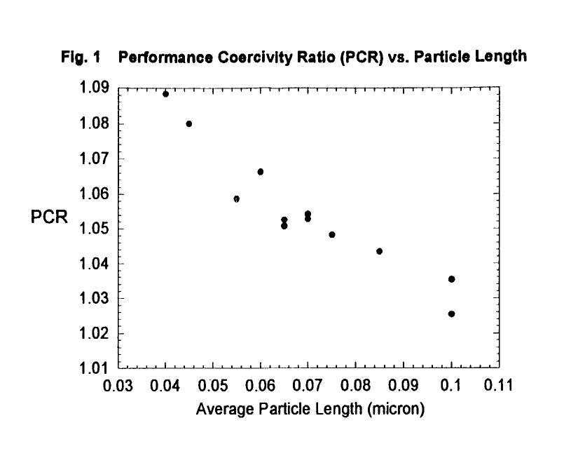

Commercially available high performance magnetic recording media, such as DVCPro™ sold by Panasonic and DDS4 sold by Fujifilm, were tested in accordance with the time-scale coercivity test methods set forth herein and found to have a PCR value of about 1.034 and 1.015 respectively. The First and Second Sharrock Articles include tables of test data for various binder-containing magnetizable layers which include values for H_{c(high)} and H_{c(low)} from which a PCR value can be calculated. The calculated PCR value for these magnetizable layers is between 1.025 and 1.054. FIG. 1 shows values of PCR for a number of test tapes containing commercially available particles of partially metallic composition (known in the industry as “MP”), which are smaller than those currently used in commercially available recording media. In FIG. 1, the PCR is plotted against the average particle length, with average particle length estimated by the manufacturers of the particles. As can be seen, a relationship exists between PCR and average particle length. Thus, PCR provides a convenient nondestructive means of estimating average particle length in finished media.

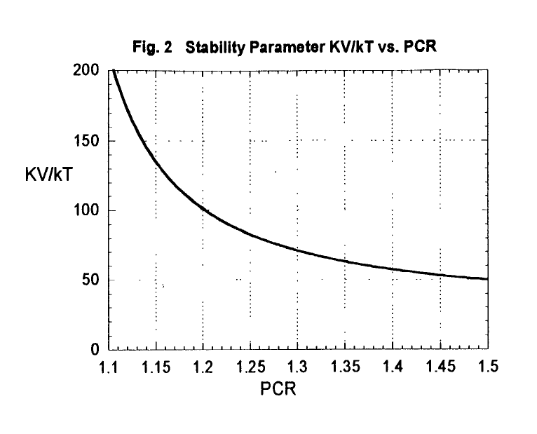

Using methods set forth in the First and Second Sharrock Articles, it is possible to extract from the value of the PCR a value for the parameter KV/kT, which is commonly used in the magnetic recording industry to characterize magnetic stability. In this parameter, K is the magnetic anisotropy constant, V is the volume of the particle or other effective magnetic switching unit, k is Boltzmann's constant, and T is the-absolute temperature. FIG. 2 shows the relationship between the PCR and KV/kT.

Magnetic recording tapes do not currently utilize magnetic microstructure (e.g., particle size) sufficiently small that magnetic stability is close to the minimum practical level. In the rigid-disk industry, however, smaller microstructure is currently used, and magnetic stability is of concern. In the rigid-disk industry, it is considered that magnetic instability will be negligible for values of the parameter KV/kT greater than about 80 and acceptable in practical applications for values greater than about 60. See, Alex, Michael, and Wachenschwantz, David, “Thermal Effects and Recording Performance at High Recording Densities,” IEEE Transaction on Magnetics, vol. 35, pp. 2796-2801, September, 1999, and Weller, Dieter, and Moser, Andreas, “Thermal Effect Limits in Ultrahigh-Density Magnetic Recording,” IEEE Transaction on Magnetics, vol. 35, pp. 4423-4439, November, 1999. FIG. 2 shows that KV/kT will be greater than 60 in media for which the PCR has a value of less than about 1.4.

Accordingly, the test method of this invention reveals an entire range of magnetically stable magnetizable layers having smaller magnetic microstructure, and therefore potentially higher SNR than those previously disclosed. The described magnetic recording media have a PCR of at least 1.06 and less than about 1.4.

I claim:

1. A magnetic recording medium, comprising:
(a) a substrate, and
(b) a magnetizable layer provided on the substrate including a binder and a plurality of magnetic pigment particles, wherein the layer has a performance coercivity ratio of at least 1.06.

2. The magnetic recording medium of claim 1 wherein the magnetizable layer has a performance coercivity ratio of at least 1.07.

3. The magnetic recording medium of claim 1 wherein the magnetizable layer has a performance coercivity ratio of at least 1.08.

4. The magnetic recording medium of claim 1 wherein the magnetizable layer has a performance coercivity ratio of less than 1.4.

5. The magnetic recording medium of claim 2 wherein the magnetizable layer has a performance coercivity ratio of less than 1.4.

6. The magnetic recording medium of claim 3 wherein the magnetizable layer has a performance coercivity ratio of less than 1.4.

7. The magnetic recording medium of claim 1 wherein the magnetic pigment particles have a partially or completely metallic composition.

8. The magnetic recording medium of claim 2 wherein the magnetic pigment particles have a partially or completely metallic composition.

9. The magnetic recording medium of claim 3 wherein the magnetic pigment particles have a partially or completely metallic composition.

10. The magnetic recording medium of claim 4 wherein the magnetic pigment particles have a partially or completely metallic composition.

11. The magnetic recording medium of claim 5 wherein the magnetic pigment particles have a partially or completely metallic composition.

12. The magnetic recording medium of claim 6 wherein the magnetic pigment particles have a partially or completely metallic composition.

13. A method of assessing signal-to-noise ratio and magnetic stability of a magnetizable layer on a magnetic recording medium wherein the information storing layer includes a plurality of magnetic pigment particles, comprising:
(a) obtaining a sample of the magnetic recording medium,
(b) recording a first magnetic hysteresis loop for the sample using a first maximum magnetic field so as to obtain a first coercivity value measured at a first field sweep rate for the magnetizable layer on the magnetic recording medium, wherein the first maximum magnetic field is sufficient to switch essentially all of the magnetic moment,
(c) recording a second magnetic hysteresis loop for the sample using a second maximum magnetic field so as to obtain a second coercivity value measured at a second field sweep rate for the magnetizable layer on the magnetic recording medium, wherein (i) the second maximum magnetic field is sufficient to switch essentially all of the magnetic moment, and (ii) the first sweep rate is at least 1,000 times greater than the second sweep rate, and
(d) calculating a coercivity ratio for the magnetizable layer on the magnetic recording medium by dividing the first coercivity value by the second coercivity value.

14. The method of claim 13 wherein the first sweep rate is 1 to 3 MOe/s.

15. The method of claim 14 wherein the second sweep rate is 20 to 40 Oe/s.
